(19) United States
(12) Patent Application Publication
(10) Pub. No.: US 2012/0212592 A1
(43) Pub. Date: Aug. 23, 2012

(54) ADJUSTMENT SYSTEM FOR DIPVERGENCE AND/OR CONVERGENCE OF A STEREOSCOPIC IMAGE PAIR

(75) Inventors: Robert S. Breidenthal, Bolton, MA (US); Joseph N. Forkey, Princeton, MA (US); Robert N. Ross, Gardner, MA (US); Brian E. Volk, Jefferson, MA (US)

(73) Assignee: PRECISION OPTICS CORPORATION, Gardner, MA (US)

(21) Appl. No.: 13/403,163

(22) Filed: Feb. 23, 2012

Related U.S. Application Data
(60) Provisional application No. 61/445,997, filed on Feb. 23, 2011.

(51) Int. Cl. H04N 13/04

(52) U.S. Cl. 348/54; 348/E13.075

(57) ABSTRACT

An adjustment system for use in a stereoscopic imaging system for adjusting the dipvergence and/or convergence of a displayed stereo image pair. A plano-plano window is mounted for tilting in one of the image paths thereby to enable the correction of dipvergence shifts, the adjustment of convergence or both.

### CROSS REFERENCE TO RELATED APPLICATION

This application claims priority from copending U.S. Provisional Application Ser. No. 61/445,997 filed Feb. 23, 2011 for an Adjustment System for Dipvergence and/or Convergence of a Stereoscopic Image Pair.

### BACKGROUND OF THE INVENTION

1. Field of the Invention

This invention generally relates to the display of stereoscopic images on a three-dimensional display and more specifically to the three-dimensional display of images obtained from a stereoscopic imaging system.

2. Description of Related Art

As known, humans have a natural stereoscopic image viewing capability. The separation of their left and right eyes causes them to view an object from two directions of view. Likewise, electro-optical devices today can produce a three-dimensional stereoscopic image by viewing an object simultaneously from two separate directions. The resulting images from the two optical viewing directions are overlaid on a stereoscopic display such that one image is observed by the right eye and the other by the left eye. The human brain then perceives depth from the lateral displacement, or parallax, between corresponding parts of the images. Many devices in use today have the capability of generating image pairs that form three-dimensional stereoscopic images viewable to a user on three-dimensional (3D) displays. The use of this technology is becoming prevalent in the movie and entertainment industry. It is also becoming an important feature in health care surgical diagnostic devices such as stereoscopic endoscopes and camera systems.

As will be appreciated, surgical stereoscopic endoscopes and camera systems are precision optical instruments. Each creates matched image pairs of an object inside the body during surgical procedures that are displayed for stereoscopic viewing. The better the quality and alignment of the stereoscopic images, the better the three-dimensional perception will appear to the medical personnel using the device. The variables for matching image quality include focus, magnification, field of view and distortion. The variables for matching alignment include “dipvergence” and “convergence” of the stereoscopic image pair.

“Dipvergence” is vertical line-of-sight misalignment between the images in an image pair when viewed on 3D display. Stated differently, it is a vertical angular disparity between the lines of sight of the left and right images as displayed on a 3D display. Depending upon the context, in the following discussion “dipvergence shift” and “dipvergence error” represent the magnitude of the misalignment.

“Convergence” is the horizontal alignment of the images of an object at a specific desired distance when viewed on a 3D display. Proper convergence is defined as a perfect overlay of the images in the image pair at the desired object distance or “convergence point.” Depending upon the context, in the following discussion “convergence shift” and “convergence error” represent the distance between the actual convergence point for the stereoscopic endoscope assembly and the ideal convergence point for the object being viewed.

As between dipvergence and convergence error, a user's eyes are more sensitive to misalignments in dipvergence between the stereoscopic image pair. Therefore it will be apparent that any three-dimensional system, particularly such systems for use in medical applications, should optimize the optics to minimize the effects of dipvergence errors. Also, because the same stereoscopic endoscope system may be used for different procedures, it is desirable to be able to easily modify the convergence point of the system depending on the expected location of objects for each specific procedure.

Today a typical stereoscopic endoscope system includes a stereoscopic endoscope assembly, a stereoscopic camera assembly and a stereoscopic image display assembly. Each assembly comprises many subassemblies and internal components, all of which contribute to a wide range of inherent manufacturing tolerances that can accumulate to introduce noticeable dipvergence shift or misalignment and an improper convergence shift or misalignment in a 3D display.

It is common practice to manufacture stereoscopic endoscope systems by fabricating components and assemblies to very tight tolerances so that endoscopes and camera assemblies can be interchanged without causing a noticeable perceived misalignment from system to system. However, even if a manufacturer adopts the use of and accepts the costs of tightly controlled manufacturing tolerances, there may still be cumulative misalignments that contribute to noticeable dipvergence and convergence errors between the images of image pairs when viewed on 3D displays.

U.S. Pat. No. 6,191,809 (2001) to Hori et al. discloses one method for changing dipvergence and convergence alignment by electronically adjusting the overlapping video displays of one channel relative to the other channel in the display electronics. For simplicity and cost, many display systems do not incorporate this capability.

What is needed is a system that facilitates the correction of errors in dipvergence and allows easy adjustment of convergence, that can be constructed economically, and that is easy to use thereby to facilitate the adjustments as different assemblies are substituted or exchanged in a given stereoscopic imaging system, such as a stereoscopic endoscope system and when a given stereoscopic imaging system is used for different procedures.

### SUMMARY

Therefore, it is an object of this invention to provide an adjustment system for use in stereoscopic imaging system that corrects dipvergence errors, convergence errors or both.

Another object of this invention is to provide an adjustment system for use in a stereoscopic imaging system that corrects dipvergence errors, convergence errors or both and that is economical to construct and easy to use.

Still another object of this invention to provide an adjustment system for use in a stereoscopic endoscope imaging system that corrects dipvergence errors, convergence errors or both.

Yet another object of this invention is to provide an adjustment system for use in a stereoscopic endoscope imaging system that corrects dipvergence errors, convergence errors or both and that is easy to use.

In a stereoscopic imaging system constructed in accordance with one aspect of this invention, first and second images are directed along first and second image paths for being viewed on a three-dimensional display wherein the displayed images are subject to misalignment in the direction of a first of two orthogonal displayed image axes. An image adjuster mechanism adjusts the misalignment. More specifically, an optical structure in the first of the image paths is angularly tiltable about a first tilt axis that corresponds to the second orthogonal displayed image axis. An exiting light beam from the optical structure deviates in a direction that corresponds to the first orthogonal display image axis to a path that is parallel with and offset from an entering light beam. A first tilt control structure connects to the optical structure to adjust the tilt of the optical structure about the first tilt axis thereby to adjust the misalignment of the first and second displayed images in the direction of the first orthogonal displayed image axis.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of one embodiment of a stereoscopic endoscope system comprising an adjustment system for implementing this invention;

FIG. 2 is a perspective view of one embodiment of the adjustment system that embodies this invention and that could be positioned inside a stereoscopic camera system of FIG. 1;

FIG. 3 is a plan view of two plano-plano optical windows showing the image effect of a tipped versus non-tipped window;

FIG. 4 is a perspective view of an alternate embodiment of an adjustment mechanism;

FIG. 5 is a view that depicts in a block functional form another embodiment of an adjustment mechanism;

FIG. 6 is a perspective view of still another embodiment of an adjustment mechanism;

FIG. 7 is a perspective view of yet another embodiment of an adjustment mechanism;

FIG. 8 is perspective view of another embodiment of a stereoscopic camera assembly with dipvergence adjustment only; and

FIGS. 9 and 10 are views of the stereoscopic camera assembly of FIG. 8 in partial cross-section with a portion of the housing removed from the camera assembly of FIG. 8.

### DESCRIPTION OF ILLUSTRATIVE EMBODIMENTS

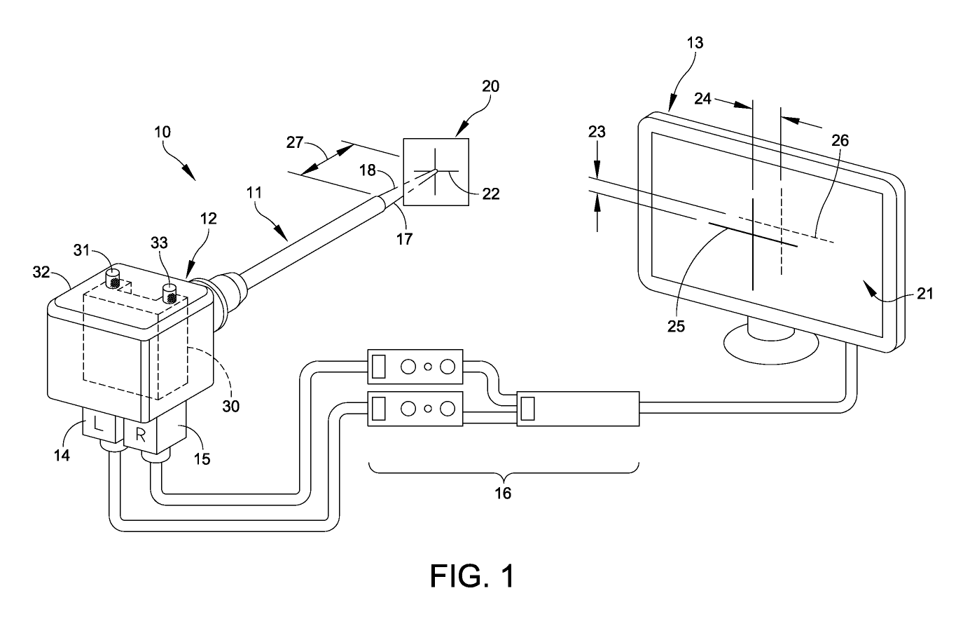

FIG. 1 depicts a stereoscopic endoscope system 10 that comprises a stereoscopic endoscope assembly 11, a stereoscopic camera assembly 12 and a three-dimensional (3D) display assembly 13. The stereoscopic camera assembly 12 includes left and right detectors 14 and 15 that generate electronic instances of each image in an image pair. System electronics 16 process the output signals from the detectors 14 and 15 for display on the 3D display 13.

More specifically, the stereoscopic endoscope 11 defines a right viewing image path 17 and a left viewing image path 18 along which a stereoscopic image pair transfers from an object 20 being viewed. Each of the detectors 14 and 15 in this particular embodiment comprises a charged coupled device (CCD) but other detector types can be substituted in other embodiments of this invention. System electronics 16 process the signals from the detectors 14 and 15 to produce an image 21 for being viewed on the 3D display 13. Such systems are known in the art.

Although an object generally is a three-dimensional object, for purposes of understanding this invention the object 20 in FIG. 1 is a single cross hair 22 located on a flat surface. As shown the displayed stereoscopic image 21 exhibits dipvergence shift 23 and convergence shift 24 in the images of the image pair being displayed. The left view 25 of the stereoscopic image 21 corresponds with the left viewing image path 18 of the cross hair 22 and the right view 26 of the stereoscopic image 21 corresponds with the right viewing image path 17 of cross hair 22.

As previously indicated, misalignments between images 25 and 26 of the stereoscopic image 21 are a direct result of the manufacturing tolerances and misalignments of the stereoscopic endoscope system. These include the affects of tolerances and misalignments beginning with the orientations of the right side image path 17 and the left side image path 18, the optical elements within the stereoscopic endoscope assembly 11 and the stereoscopic camera assembly 12 including the position of the detectors 14 and 15. Also contributing are electronic signal mapping errors introduced by the system electronics 16.

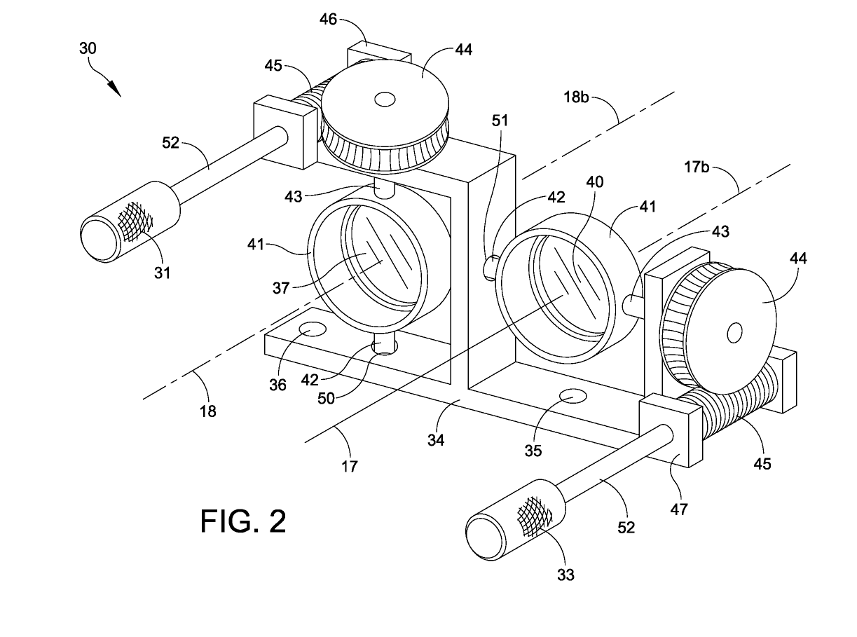

As shown in FIG. 1, dipvergence shift 23 is the vertical misalignment between left image 25 (shown as solid lines in FIG. 2) and the right image 26 (shown as dashed lines). For an optimal image the dipvergence shift 23 should be zero. Likewise the convergence shift 24 is a horizontal shift between left image 25 and the right image 26 in the stereoscopic image 21. As known, the convergence shift 24 is also directly affected by object distance 27. The convergence shift 24 determines the stereoscopic effect that the system will display. As also known, the dipvergence shift 23 and convergence shift 24 at the display are defined by first and second displayed image orthogonal axes. In this specific embodiment the first and second displayed image orthogonal axes extend horizontally, for convergence, and vertically for dipvergence.

In use, stereoscopic endoscopes and cameras are intended to be interchangeable. The perceived dipvergence shift 23 and convergence shift 24 may be different for each combination of an individual stereoscopic endoscope assembly 11 and stereoscopic camera assembly 12. In order to adjust the dipvergence shift 23 and convergence shift 24 for optimal use in accordance with this invention, the embodiment in FIG. 1 incorporates an adjustment mechanism 30 located within the stereoscopic camera assembly and depicted with dashed lines. A control knob 31 protrudes from the top of the camera housing 32 to act as a means for adjusting convergence shift 24. A control knob 33, also protruding from the top of the camera housing 32, provides a means for adjusting dipvergence shift 23.

FIG. 2 is a view taken from above the stereoscopic camera assembly 12 and depicts one embodiment of an image adjustment mechanism 30 for controlling dipvergence and convergence of a stereo image pair formed by the right viewing image path 17 and the left viewing image path 18. The adjustment mechanism 30 has a frame 34 with mounting holes 35 and 36 to enable attachment to the camera housing 32. The left viewing image path 18 passes through a left-side plano-plano window 37 and the right viewing image path 17 passes through a right-side plano-plano window 40.

Plano-plano windows constitute a category of optical beam adjuster used in the optical industry. When a plano-plano window in the optical path tips, the light beam deviates in the plane of tip based on the angle of tip, the window material and the window thickness. However, the exiting light beam remains parallel to the entrance light beam thereby preventing image tilt on a sensor and maintains a constant magnification during adjustment. The optical properties of a tipped plano-plano window are ideally suited to the performance of the required adjustment needed in the matched stereo image pair. Other types of window may create image distortion that has a negative effect on the quality of the displayed image. However, a true plano-plano window placed within an optical path designed to accommodate such a window introduces virtually no negative image effects over the small range of tipping encountered in the applications for which this invention is useful.

Plano-plano windows 37 and 40 used in this embodiment of the adjustment mechanism 30 are sized so that such a window can be tipped without clipping the image path. Each of plano-plano windows 37 and 40 is held in a separate window bezel 41. Each window bezel 41 has pivot post 42 fixedly mounted to the outside of the bezel side wall and each window bezel 41 has a gear mounting shaft 43 fixedly mounted to the outside of the bezel wall in axial alignment with axis of the pivot post 42.

FIG. 2 depicts worm gear sets, each comprising a worm gear 44 and a worm 45 mounted to the end of each worm gear shaft 43 and supported by a worm mount 46 or 47 fixedly attached to the frame 34. The frame 34 has a pivot hole 50 and a pivot hole 51 positioned perpendicular to each other. The pivot hole 50 has a vertical centerline that passes through the center line of the left viewing image path 18; the pivot hole 51 has a horizontal centerline passing through the right side viewing image path 17. Each of pivot holes 50 and 51 has a rotating fit with a corresponding pivot post 42 and gear mounting shaft 43. Each worm 45 also has an adjusting shaft 52 that attaches to its respective control knob 31 or 33.

When the components are assembled, turning the control knob 33 adjusts the tip angle of the right side plano-plano window 40 by rotating it about a horizontal tilt axis to adjust the right-side image path 17. The horizontal tilt axis corresponds to the vertical displayed image axis thereby to produce a desired exiting beam axis 17b relative to the left side image path 18b to correct dipvergence shift or error. Likewise, turning the control knob 31 adjusts the tip angle of the attached plano-plano window 37 to adjust the left side image path 18 to produce a desired exiting beam along an axis 18b to correct convergence shift or error relative to the right-side image path 17b. In this case the second tilt axis is vertical to correspond to the horizontal one of the orthogonal displayed image axes to adjust the convergence misalignment 24 of the displayed images 25 and 26.

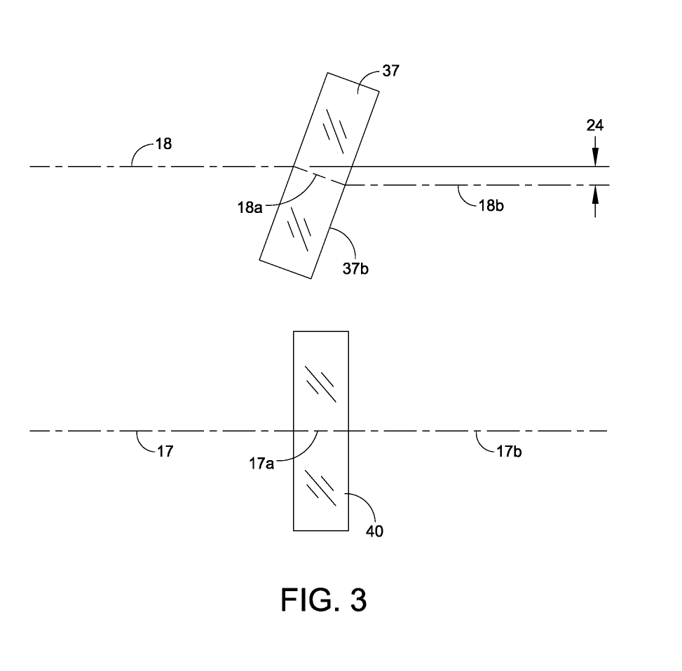

More specifically, FIG. 3 depicts the right-side viewing path 17 and the left-side viewing path 18 along which are received images in an image pair. A plano-plano window inserted within each path. Specifically, a window 40 is positioned in the right-side image path 17 and window 37 is positioned in the left-side image path 18. In FIG. 3, the window 40 is normal to the viewing path 17 and is not tipped. Consequently the viewing path 17a does not deviate through the window 40, so the exiting image path 17b is axially aligned with the input viewing path 17.

In FIG. 3, the window 37 is tipped relative to the input of the viewing image path 18 resulting in a deviating path 18a through the window 37. At an exit surface 37b, the exiting image path 18b is shifted by a vertical vector component corresponding to convergence shift 24 of the deviation path 18a. After exiting the window surface 37b, the exiting image path 18b continues in a path parallel to the input image path 18. The amount of tipping determines the level of deviation or offset of the beam.

The worm gear sets used in embodiment of FIG. 2 produce incremental angular adjustments for each of the windows 37 and 40, and the gear ratio can be adjusted by the use of differently pitched gear sets and different gear diameters. In a stereoscopic endoscope system it can become necessary or advantageous to use a gear set ratio of 120:1 or greater.

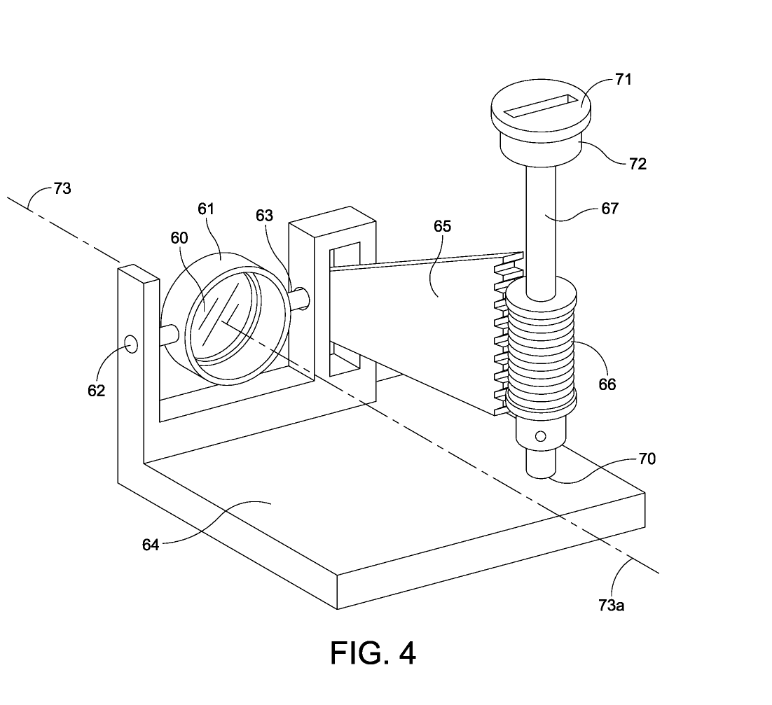

However, in many cases the worm gear diameters may be so large as to prevent their use in a compact enclosure as encountered in a stereoscopic endoscope system. FIG. 4 depicts an adjustment mechanism that uses a large diameter worm gear segment. In this embodiment a plano-plano window 60 mounts in a bezel 61, and a pivot pin 62 attaches to the outside edge of the bezel 61. A gear mounting shaft 63 attaches to the bezel 61 on the opposite side to allow the bezel 61 to pivot. The assembly mounts on a frame 64 having aligned holes for rotary fit with the pivot pin 62 and the gear mounting shaft 63. The worm gear segment 65 attaches to the gear mounting shaft 63. The worm 66 attaches to a vertical shaft 67 in FIG. 4 that rotates in a bearing 70 in the frame 64 and meshes with the worm gear segment 65. By using a worm gear segment with a large diameter for the gear adjustment, it is possible to reduce the overall size of the adjustment mechanism. An operator or turning knob 71 has a bearing surface 72 for engaging a mating surface. In use turning the knob 71 rotates the worm 66 and pivots the worm gear segment 65 in a vertical plane and the attached shaft 63 about the horizontal axis. The window 60 thereby causes an input image path 73 to deviate to a desired output image path 73a in a vertical plane to adjust and minimize any dipvergence effect.

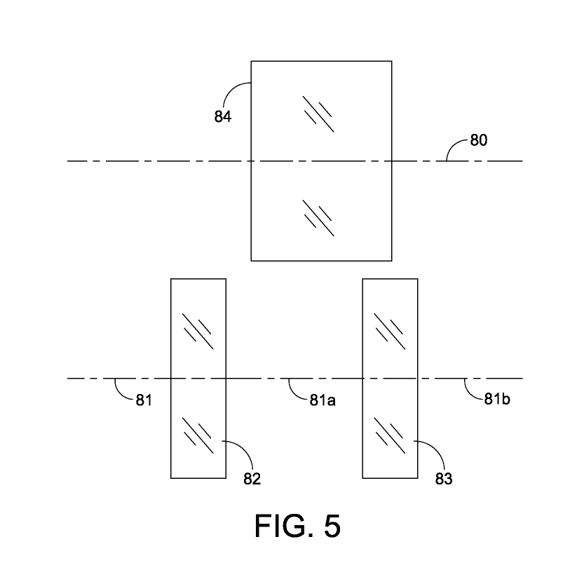

FIG. 5 schematically depicts another embodiment of an adjustment mechanism that incorporates two plano-plano windows in one image viewing path to adjust dipvergence and convergence of one beam or image path relative to the other beam or image path. In FIG. 5 image paths 80 and 81 define the two paths for an image pair. Although image path 80 does not include a tipping window, the image path 80 may include a fixed position window 84 to create an equivalent glass path to match the glass path for image path 81. In this embodiment, image path 81 contains two adjustable plano-plano tipping windows 82 and 83. Plano-plano window 82 adjusts the image path to a first deviated image path 81a using any of the foregoing or other adjustment mechanisms to correct for one of the dipvergence and convergence errors. Plano-plano window 83 tips in a plane orthogonal to the tipping plane of window 82 to adjust first deviated image path 81a in the direction of a second deviated image path 81b to correct for the other of the dipvergence or convergence errors.

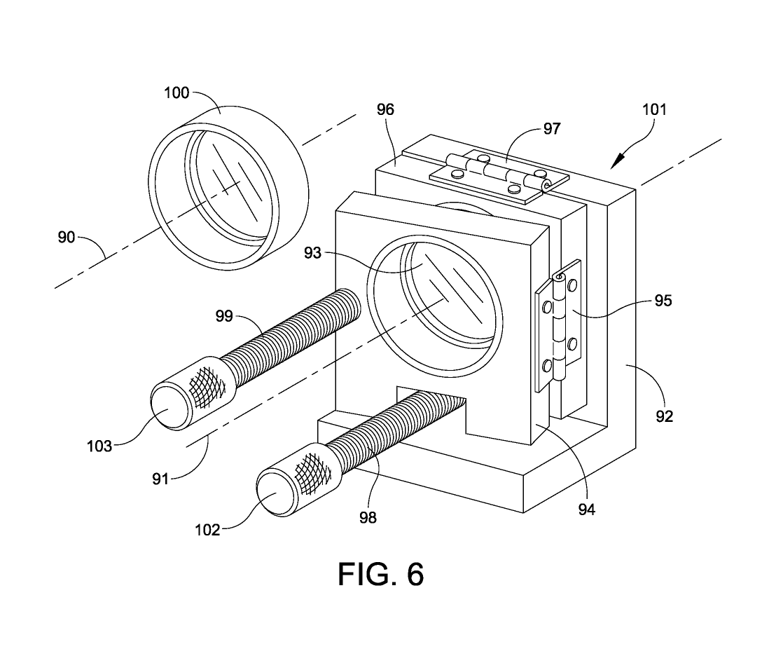

It is also possible to adjust the tip and tilt of a single plano-plano window positioned in one image path for adjustment of both dipvergence and convergence. In FIG. 6 an image pair is received along image paths 90 and 91. Image path 90 may have a fixed position plano-plano window 100 without tip adjustability to create an equivalent image path length to image path 91. Image path 91 has a plano-plano window 93 positioned in a tip-tilt holder 101 for adjusting the tip angles of the image for both dipvergence and convergence of the stereo image pair. Window 93 is mounted in plate 94. A flexure member 95, represented as a hinge, connects plate 94 and a plate 96. Adjusting screw 99 threads into plate 94 and bears against plate 96 causing flexure 95 to bend accordingly. Rotation of the adjusting knob 103 rotates the adjusting screw 99 to tip the plano-plano window 93 about a vertical axis to correct for convergence error. The plate 96 also connects to the frame 92 by a flexure member 97, also represented as a hinge with a horizontal axis. An adjusting screw 98 has a clearance fit through plate 94 and threads into the plate 96 and bears against frame 92 causing flexure 96 to bend accordingly. Rotation of the adjusting knob 102 rotates the adjusting screw 98 to tip the plano-plano window 93 about a vertical axis to correct for dipvergence error. The adjusting knobs 102 and 103 can be rotated individually or simultaneously to adjust for both dipvergence and convergence errors.

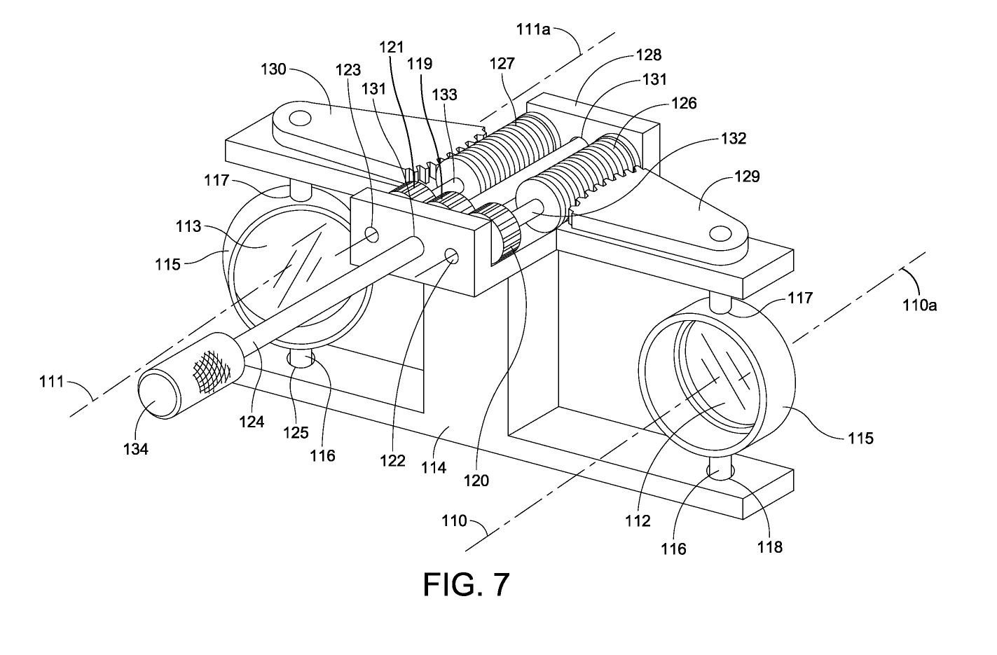

FIG. 7 depicts an adjustment mechanism embodiment that enables simultaneous convergence adjustment to both images in an image pair. That is, the embodiment in FIG. 7 enables adjustment of the convergence point by adjusting the image paths for both images in equal amounts but in opposing directions. In this embodiment, the stereo image pair is received along image paths 110 and 111. Plano-plano windows 112 and 113 are positioned in paths 110 and 111, respectively. The support structures for each of the windows 112 and 113 are mirror images of each other. Each support structure includes a bezel 115 that supports a corresponding one of the windows 112 and 113 with a pivot shaft 116 fixedly mounted to the bezel outside edge and a gear mounting shaft 117 fixedly mounted to the opposite side of the bezel 115 thereby to define spaced parallel axes of rotation for each of the windows 112 and 113. Windows 112 and 113 are positioned in a frame 114 in vertical alignment through mounting holes 118 and 125. Hole 118 is centrally positioned normal to image path 110. Hole 125 is parallel with the hole 118 and is centrally positioned normal to image path 111. Hole 118 carries the pivot shaft 116, gear mounting shaft 117 and plano-plano window 112 with its bezel 115. Plano-plano window 113 with its bezel 115, pivot pin 116 and gear mounting shaft 117 is positioned in the hole 125.

A multi-gear assembly carried by a frame 114 is adapted to tip plano-plano windows 112 and 113 toward or away from each other about vertical axes in FIG. 7, but in opposite directions to produce a mirrored motion. The multi-gear assembly in this embodiment is comprised of a driver gear 119 fixedly attached to an adjusting shaft 124. The adjusting shaft 124 rotates in holes 131 in the frame 114. When the adjusting shaft 124 rotates, the driver gear 119 rotates simultaneously. This turns a pinion gear 120 and worm 126 that both are attached to a shaft 132 having a rotary fit in holes, such as the hole 122, in frame 114. At the same time, the pinion gear 121 and left hand worm 127, both attached to a shaft 133 mounted in the hole 123. Holes 131, 122 and 123 in frame 114 are parallel offset by the diametrical pitch of the pinion gears 119, 120 and 121.

A mirrored adjustment is created by two worm gear sets, As the worm 126 turns, it rotates segmented worm gear 129 on the gear mounting shaft 117 thus tipping plano-plano window 112 in a plane axially centered with hole 118. As the worm 127 turns, it rotates segmented worm gear 130 mounted to the gear mounting shaft 117 thus tipping plano-plano window 113 in a plane axially centered with hole 125.

Since the pivots for the worm gears 129 and 130 are on opposite sides of the worm gear sets, the plano-plano windows 112 and 113 undergo opposite tipping. Thus, in use an adjuster knob 134 attached to the adjusting shaft 124 simultaneously adjusts the convergence of the image paths 110 and 111 to produce output image paths 110a and 111a. This adjustment mechanism has an advantage. This allows for the adjustment of the convergence point along the mechanical axis of the stereoscopic endoscope without displacing the convergence point laterally. Moreover adding a single adjustment mechanism for dipvergence in one of the image paths 110 or 111 would provide full adjustment of dipvergence and convergence of the image pair.

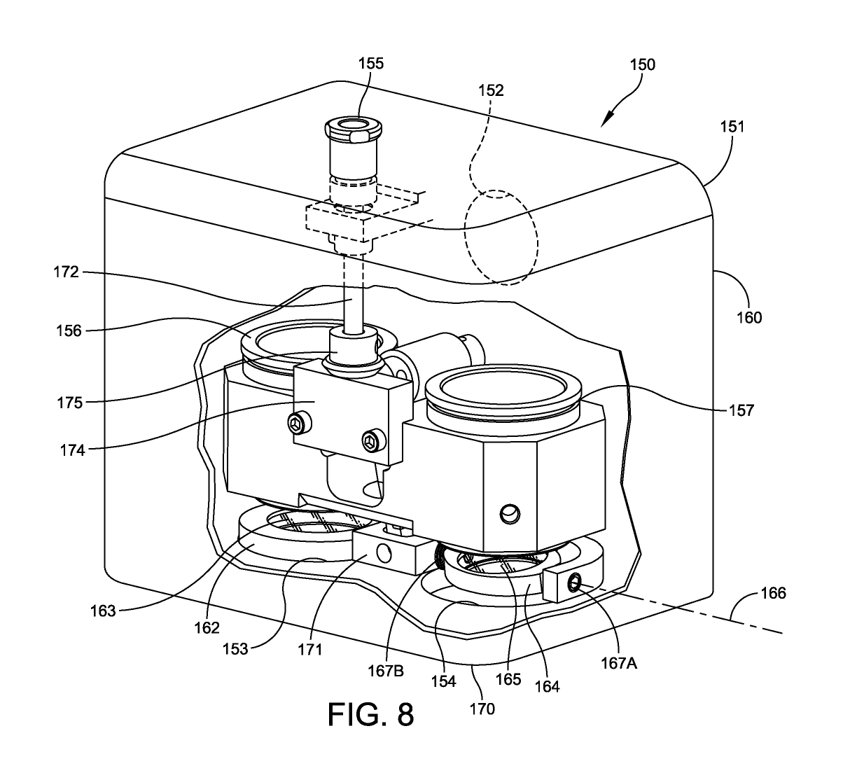

FIGS. 8, 9 and 10 depict different portions of a stereoscopic camera system 150 having the same basic construction as the camera assembly 30 in FIG. 1. This system 150 provides dipvergence adjustment only. It includes a housing 151 connected to the proximal end of a stereoscopic endoscope (not shown) that attaches to a passage 152 formed in the housing. Camera systems, also not shown but similar to those shown in FIG. 1, attach to the bottom of the housing in alignment with passages 153 and 154 to capture the left and right images, respectively. Connections from the camera systems to electronic image processing and projection equipment are not shown. An external control knob 155 provides the means for minimizing dipvergence.

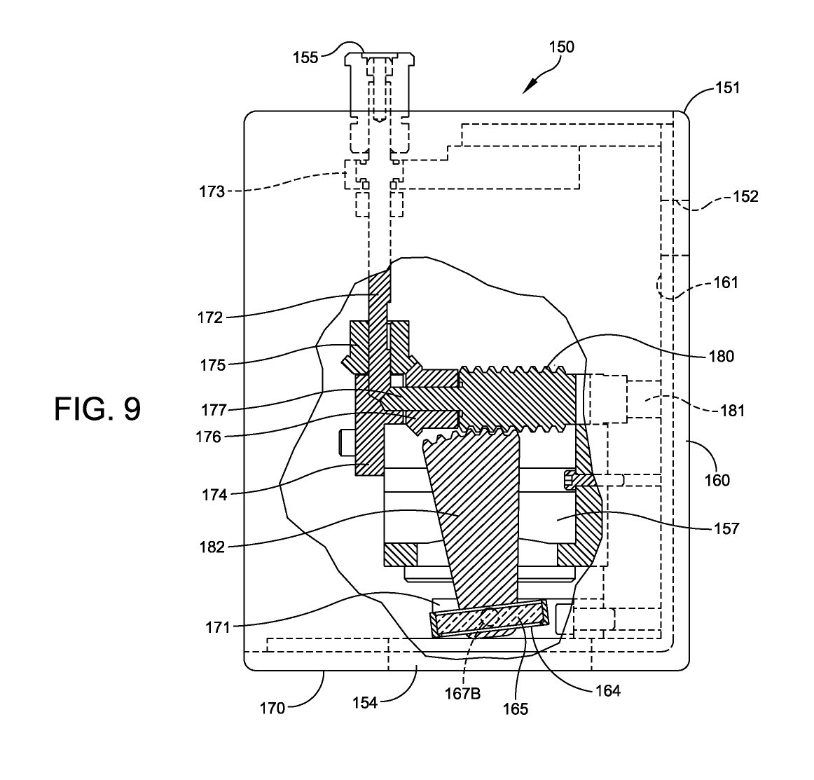

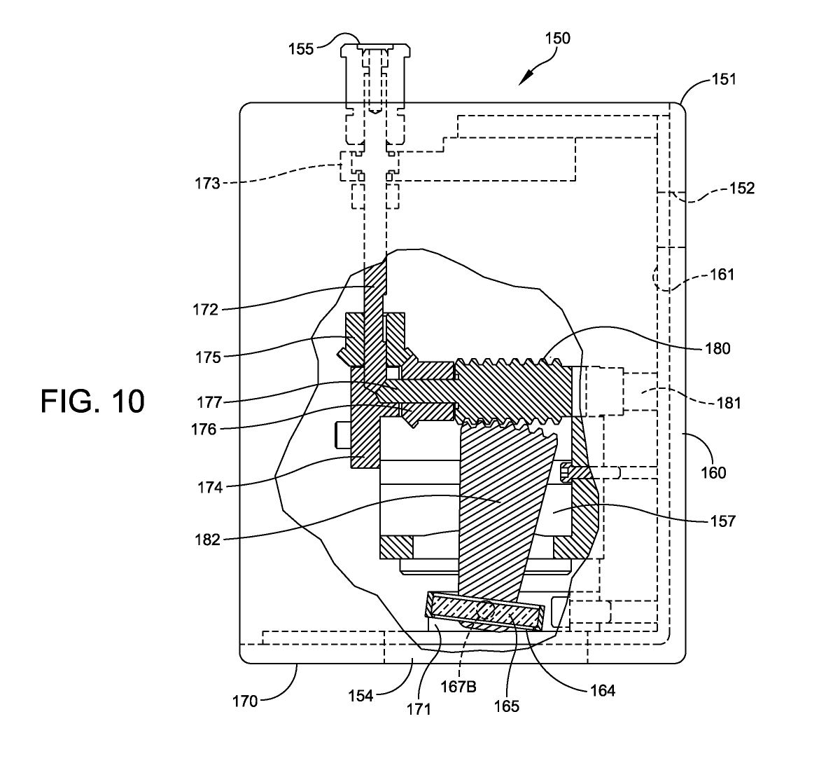

Lens cells 156 and 157 in FIG. 8 mount to a vertical wall 160 that also includes an attachment plate 161 as shown if FIGS. 9 and 10 for connection to the proximal end of a stereoscopic endoscope, not shown in these figures. FIGS. 8, 9 and 10 also do not disclose various optical components such as mirrors, prisms and the like, that redirect the first and second image paths from the stereoscopic endoscope into vertical image paths centered on the lens cells 156 and 157. The arrangement of such optical components for this purpose is known in the art.

A fixed window mount 162 intermediate the lens cell 156 and camera system passage 153 supports a plano-plano window 163 in a fixed position. A tiltable window mount 164 intermediate the lens cell 157 and camera system passage 154 supports a plano-plano window 165 for being tilted about an axis 166 thereby to offset the image arriving through the camera system passage 154 vertically and minimize or otherwise adjust dipvergence shift. In this embodiment the axis 166 corresponds to the vertical one of the orthogonal displayed image axes. Rotation about the axis 166 is achieved by shafts, such as a shaft 167A that extends from the mount 164 in the form of a yoke, block or equivalent component to be supported for rotation about the axis 166. A central block 171, also mounted to the horizontal extension 170, acts as a journal for a second shaft 167B from the mount 164.

As previously indicated, the control knob 155 provides adjustment by tilting the mount 164 about the horizontal axis that intersects both image paths within the camera system 150 because that is the axis that corresponds to the dipvergence displayed image axis. Referring to FIGS. 9 and 10, the control knob 155 rotates a shaft 172 carried by upper and lower journals formed in blocks 173 and 174. The shaft 172 also has a bevel gear 175 that mates with a second bevel gear 176 on a horizontal shaft 177 that carries a worm gear 180 and that is supported along a horizontal axis by the block 174 and a block 181 attached to the vertical wall 160.

Rotation of the control knob 155 causes the bevel gear 175 to rotate the worm 177 and a segment 182 that pivots about a horizontal axis in the block 171 attached to the shaft 167B extending from the tiltable mount 164 through the segment gear. As a result, the tiltable window 164 rotates about the axis 166 and causes the image path to deviate as previously described to bring the image paths into vertical alignment and to minimize the effects of dipvergence on the displayed image. FIGS. 9 and 10 depict the positioning of the segment 182 and the tiltable mount 164 near the maximum deflections. As a result, a range of dipvergence corrections can be made within the limits of rotation of the tiltable mount 164.

As will now be apparent, there have been disclosed a number of specific mechanisms that can implement a stereoscopic imaging system that meets the objectives of this invention. Each of the various embodiments provides an adjustment system for use in a stereoscopic imaging system that corrects unwanted dipvergence, convergence or both. Each adjustment system is economical to construct an easy-to-use. Moreover each adjustment system is readily adapted for use in stereoscopic endoscope imaging systems.

This invention has been disclosed in terms of certain embodiments. It will be apparent that many modifications can be made to the disclosed apparatus without departing from the invention. For example, other mechanisms could be constructed that incorporate the features of various specific embodiments of this invention in alternative and equivalent assemblies. Each of the specifically disclosed embodiments assumes that there is a direct correspondence between tilt axes and orthogonal displayed image axes and more specifically that the orthogonal displayed image axes are horizontal and vertical and that the tilt axes are also horizontal and vertical. However this invention is not limited to such a direct correspondence. Other arrangements can be implemented so long as there is a predetermined correspondence or relationship between the displayed image orientation and the various tilt axes. As previously indicated, other optical assemblies might be substituted for the preferred plano-plano lenses with the attainment of some or all of the advantages of the specifically disclosed embodiments. All of the tilt control structures have been disclosed with conventional gear apparatus; other non-gear apparatus might be substituted to provide the limited rotary motion of the plano-plano windows. Therefore, it is the intent of the appended claims to cover all such variations and modifications as come within the true spirit and scope of this invention.

What is claimed is:

1. In a stereoscopic imaging system wherein first and second images are directed along first and second image paths for being viewed on a three-dimensional display wherein the displayed images are subject to misalignment in the direction of a first of two orthogonal displayed image axes, an image adjuster mechanism comprising:
A) an optical structure in the first of the image paths that is angularly tiltable about a first tilt axis that corresponds to the second orthogonal displayed image axis thereby to cause an exiting light beam from said optical structure to deviate in a direction that corresponds to the first orthogonal display image axis to a path that is parallel with and offset from an entering light beam, and
B) a first tilt control structure connected to said optical structure to control the tilt of said optical structure about the first tilt axis thereby to adjust the misalignment of the first and second displayed images in the direction of the first orthogonal displayed image axis.

2. A stereoscopic imaging system as recited in claim 1 wherein said optical structure includes a plano-plano window and a frame tiltable about the first tilt axis.

3. A stereoscopic imaging system as recited in claim 2 wherein said adjuster mechanism additionally includes a housing and wherein said tilt control structure includes:
i) a gear train having at least one gear that is rotatable in said housing whereby said frame and plano-plano window rotate about the first tilt axis, and
ii) a mechanical control enables rotation of said gear train.

4. A stereoscopic imaging system as recited in claim 2 wherein said optical structure mounts to a frame and first tilt control structure includes a support for defining an axis of rotation, a shaft to which is mounted said optical structure a worm gear segment attached to said shaft, a worm gear and a vertically disposed operator on said frame that carries said worm gear meshed with said gear segment whereby rotation of said knob causes said optical structure to tilt about the tile axis.

5. A stereoscopic imaging system as recited in claim 2 wherein one of the orthogonal displayed image axes is a vertical axis along which dipvergence occurs and wherein the image paths at the image adjuster are vertical and said first optical structure pivots about a horizontal axis that corresponds to a horizontal tilt axis.

6. A stereoscopic imaging system as recited in claim 2 additionally comprising a second plano-plano window fixed in and normal to the second image path, said second plano-plano window having the optical properties that correspond to the optical properties of said plano-plano window in the first image path.

7. A stereoscopic imaging system as recited in claim 1 wherein the displayed second image is subject to misalignment in the direction of the second orthogonal displayed image axis and said housing supports a second image adjuster comprising:
C) a second optical structure in the second image path that is angularly tiltable about a second tilt axis that corresponds to the first orthogonal displayed image axis thereby to cause an exiting light beam from said second optical structure to deviate in a direction that corresponds to the second orthogonal displayed image axis to be parallel with and offset from an entering light beam axis, and
D) a second tilt control structure connected to said optical structure to control the tilt of said second optical structure about the second tilt axis to adjust the misalignment of the first and second displayed images in the direction of the second orthogonal displayed image axis.

8. A stereoscopic imaging system as recited in claim 7 wherein said second optical structure includes a second plano-plano window and a second frame tiltable about the second tiltable axis.

9. A stereoscopic imaging system as recited in claim 8 wherein said second adjuster mechanism additionally includes a housing and wherein said second tilt control structure includes a gear train having at least one gear that is rotatable in said housing whereby said second frame and plano-plano window rotate about the second tiltable axis and a second mechanical control enables rotation of said gear train.

10. A stereoscopic imaging system as recited in claim 9 where each of said first and second plano-plano windows have the same optical characteristics.

11. A stereoscopic imaging system as recited in claim 1 additionally comprising a second optical structure in the second of the image paths that is angularly tiltable about another tilt axis that corresponds to the second orthogonal displayed image axis thereby to cause an exiting light beam from said second optical structures to be parallel with and offset from entering light beams in a direction that corresponds to the first orthogonal displayed image axis, said tilt control structure being connected to rotate said first and second optical structures about their respective tilt axes simultaneously to adjust the misalignment of the displayed images.

12. A stereoscopic imaging system as recited in claim 1 additionally comprising a second optical structure in the first of the image paths that is attached to said first optical structure such that said second optical structure is angularly tiltable about a second tilt axis that corresponds to the second orthogonal displayed image axis and is formed in the plane of said first optical structure thereby to cause an exiting light beam from said optical structure to deviate in a direction that corresponds to the second orthogonal display image axis to a path that is parallel with and offset from an entering light beam and a second tilt control structure attached to second optical structure and independent of said first optical structure to adjust misalignment of the first and second displayed images in the direction of the second orthogonal displayed image axis.

13. A stereoscopic imaging system as recited in claim 12 wherein said first and second optical structures each includes a plano-plano window and a frame tiltable about a corresponding tilt axis.

14. A stereoscopic imaging system as recited in claim 13 additionally including a third plano-plano window positioned in the second of the image paths, said third plano-plano window having the optical properties of the combination of said first and second plano-plano windows.
